(19) United States
(12) Patent Application Publication
(10) Pub. No.: US 2006/0210027 A1
(43) Pub. Date: Sep. 21, 2006

(54) Method and system for storing and sending multimedia messaging service (MMS) messages

(76) Inventor: Oded Kafri, Tel Aviv (IL)

Correspondence Address: HENRY M. SINAI;(IP-PARTNERSHIP), P.O. BOX 669, RAANANA, 43350, IL

(21) Appl. No.: 11/375,121

(22) Filed: Mar. 15, 2006

(30) Foreign Application Priority Data
Mar. 16, 2005 (IL) 167484

(51) Int. Cl. H04M 11/00

(52) U.S. Cl. 379/88.13

(57) ABSTRACT

A method and system for storing and sending multimedia messaging service (MMS) messages is provided which allows a called party to receive a video message even though he may not have the capability to receive video. In an embodiment of the invention, the called party, who may have the capability to receive video messages but is unable to do so at that time because the telephone is busy, not answering or not switched on to receive calls, may retrieve the video message being sent to him.

### RELATED APPLICATIONS

This application claims priority from Israeli Application Number 167484, filed Mar. 16, 2005 and which is hereby incorporated by reference herein in its entirety.

### FIELD OF THE INVENTION

The present invention relates to a method and apparatus for storing and sending multimedia messaging service (mms) messages.

### BACKGROUND OF THE INVENTION

In modern telephony telephone subscribers can communicate not only by voice and text but also by a video. There are many devices that enable video calls between two or more parties. In some modern telephones there are built-in digital cameras that enable for two or more owners of such telephones subscribers of carriers providing the service to make a video calls or videoconference. One major obstacle of video calls is that many people do not have handsets that equipped with video capabilities. The second is that the called party might be busy or he is not answering or he is out of a reception area of this service

MMS stands for Multimedia Messaging Service, a technology that allows you to create, send, and receive text messages that also include an image, audio, and/or video clip. MMS messages may be sent from one mobile phone to another, or to an email address and is frequently used to send photos and videos.

MMS (Multimedia Messaging Service) is a descendent of SMS (Short Messaging Service). MMS extends text messaging to include longer text, graphics, photos, audio clips, video clips, or any combination of the above, within certain size limits.

### SUMMARY OF THE PRESENT INVENTION

The present invention allows a called party to receive a video message even though he may not have the capability to receive video. In an embodiment of the invention, the called party, who may have the capability to receive video messages via his telephone, for example, but is unable to do so at that time because the telephone is busy, not answering or not switched on to receive calls, may retrieve the video message being sent to him. In another embodiment of the invention, the transmitted video clip may be captured, stored, and then sent to the called person by other communication means such as e-mail or interactive television (ITV), for example. In a further embodiment of the invention, the stored video message may also be retrieved by a called party.

There is thus provided in accordance with an embodiment of the invention, a method for storing, sending and retrieving multimedia messaging service (MMS) messages. The method includes the steps of:

routing missed or unanswered telephone calls to an unified video mail server;

storing a message from the caller at the unified video mail server, the message includes at least one of a group of messages including text, voice and video messages;

notifying the called party that at least one message has been received from the caller; and

forwarding the stored message to the called party.

Furthermore, in accordance with an embodiment of the invention, the method further includes the step of identifying the telephone numbers of the caller and the called party from the signaling system.

Furthermore, in accordance with an embodiment of the invention, the method further includes the step of converting a video image or clip into a video file compression format; and storing the compressed video file.

Furthermore, in accordance with an embodiment of the invention, the step of notifying includes the step of sending an SMS message via a SMS Center in the telephone switch or via MWI notification (Message Waiting Indicator) to a telephone associated with the called party. Alternatively, the step of notifying includes the step of sending the message to the e-mail address associated with the called party.

Furthermore, in accordance with an embodiment of the invention, the step of notifying also includes the step of attaching any of a group of files including a wave file, photograph and video file with a text message.

Furthermore, in accordance with an embodiment of the invention, the step of notifying also includes the step of storing any of a group of file attachments on a dedicated web site for retrieval by the called party.

Furthermore, in accordance with an embodiment of the invention, the method further includes the step of the unified video mail server forwarding the message to a interactive television center (ITVC).

In addition, the method may further includes the steps of:

the ITVC storing the received message;

entering details of the message in a database file associated with the called party; and directly broadcasting a notification to the television set of the called party that a message has been received for the called party.

The step of broadcasting may include the step of transmitting an overlay message via satellite or cable.

Furthermore, in accordance with an embodiment of the invention, the method may further include the steps of:

the called party requesting details of the incoming messages; and

the ITVC transmitting the messages selected for viewing.

The step of requesting details may include the step of communicating with the ITVC via cable or via a dedicated telephone line.

In addition, there is provided in accordance with an embodiment of the invention, a method for sending SMS (Short Messaging Service) messages includes the steps of:

routing the SMS message to an unified mail server;

the unified video mail server forwarding the message to an interactive television center (ITVC); and

the ITVC broadcasting a notification to the television set of the called party that a SMS message has been received for the called party.

Furthermore, in accordance with an embodiment of the invention, the method may further include the steps of:

the ITVC storing the SMS message; and

entering details of the message in a database file associated with the called party.

Furthermore, in accordance with an embodiment of the invention, the method may further include the steps of:

the called party requesting details of the SMS messages; and

the ITVC transmitting the messages selected for viewing.

Additionally, there is provided in accordance with an embodiment of the invention, a system for storing and sending multimedia messaging service (MMS) messages which includes a router for routing missed or unanswered telephone calls, an unified video mail server in communication with the router; the unified video mail server includes at least one storage device for storing a message from the caller, a notifier for notifying the called party that a message has been received from the caller; and a forwarding device for forwarding the stored message to the called party.

Furthermore, in accordance with an embodiment of the invention, the unified video mail server further includes at least one of a group including a voice mail server and a video mail server.

Furthermore, in accordance with an embodiment of the invention, the unified video mail server further includes a video converter and a storage device for converting and compressing and storing video messages.

Furthermore, in accordance with an embodiment of the invention, the system further includes an interactive television center (ITVC) in communication with the unified video mail server. The ITVC includes a controller, a client database in communication with the controller and a file storage device in communication with the controller. The ITVC is configured to transmit messages received from the unified mail server to the Interactive Television of the called party.

### BRIEF DESCRIPTION OF THE DRAWINGS

FIG. 1 is a schematic illustration of a system for storing, sending and retrieving Multimedia Messaging Service (MMS) messages according to an embodiment of the present invention;

FIG. 2 is a schematic flow chart illustration of the communication of a video call according to an embodiment of the present invention;

FIG. 3 is a schematic illustration of a prior art mail server for use for storing, sending and retrieving text messages;

FIG. 4 is a schematic illustration of a unified video mail server for use for storing, sending and retrieving video messages;

FIG. 5 is a schematic flow chart illustration of the communication of an unanswered or missed video call to the called person, according to an embodiment of the present invention;

FIG. 6 is a schematic illustration of a television center's voice/video mail server;

FIG. 7 is a flow chart illustration of the transmission and retrieval of the text and/or video message to the called person's TV; and

FIG. 8 is a flow chart illustration of the forwarding of a SMS message to the TV set of a called party via an unified mail server.

### DESCRIPTION OF THE INVENTION

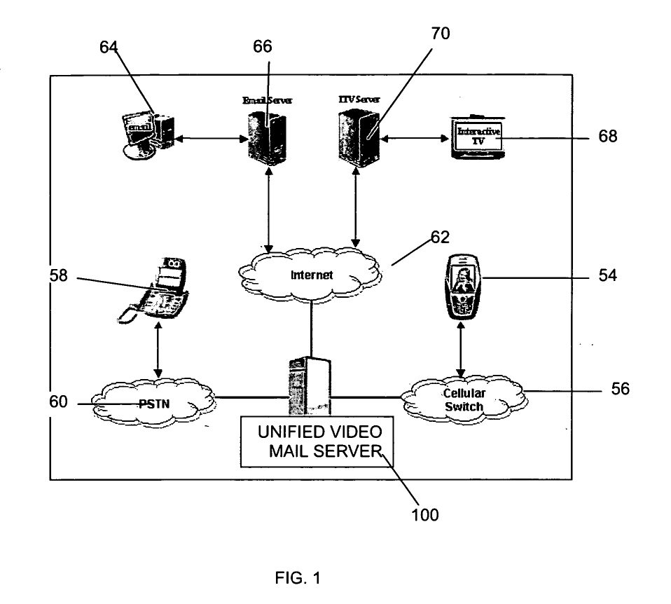

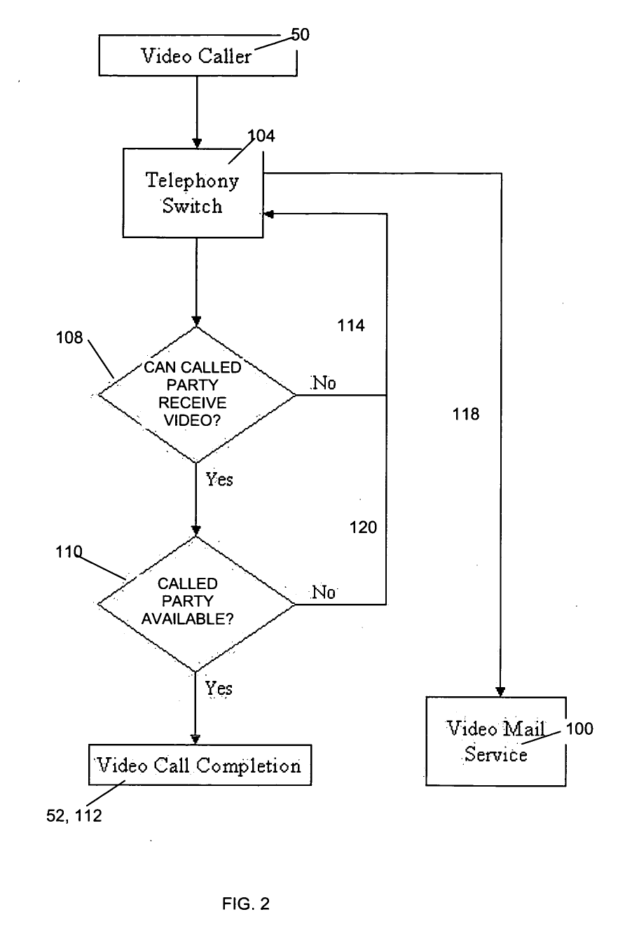

Reference is made to FIGS. 1 and 2. FIG. 1 is a schematic illustration of a system for storing, sending and retrieving Multimedia Messaging Service (MMS) messages according to an embodiment of the present invention. FIG. 2 is a schematic high level flow chart illustration of the communication of a video call utilizing the system of FIG. 1. The term ‘video’ is used herein to refer to the transmission of either still or moving images including photographs or video clips.

Generally, when a person (caller 50), using an instrument having photographic or video capabilities, wishes to make a video call or transmit a photograph or video clip to a third party (the called party 52), the call is routed via the telephony switch 104 to the called party 52. The call may be any video call such as a from a video cellular phone 54 via a cellular switch 56 or from a video phone 58, such as used for video conferencing via a PSTN 60.

In the present invention, if the call is not received because the called person cannot receive photographic images or video or because the called person telephone is busy or not answering, for example), the call may be routed to the unified video mail server 100. As described below in greater detail, the video call is converted into a compressed format to be forwarded via Internet 62, to the called person email box 64 by email server 66 or to his interactive television (ITV) 68 via an ITV server 70.

If the called party 52 has video capabilities (query box 52) and is available to receive the call (query box 110), the call and the transfer of video images is effected and communicated to the called person 52 until the call is completed (112).

If the called party does not have video capabilities (query box 52), the call is returned to the telephony switch 104 (link 114) and routed to the unified video mail server 100 (link 118). Similarly, if the called person is unavailable (busy or not answering, for example) (query box 110), the call is also returned to the telephony switch 104 (link 120) and routed to the video mail server 100 (link 118). Thus, in contrast to existing systems in which the video message is ‘lost’, the present invention allows the video call to be stored for transmittal to the called party, as will be described hereinbelow.

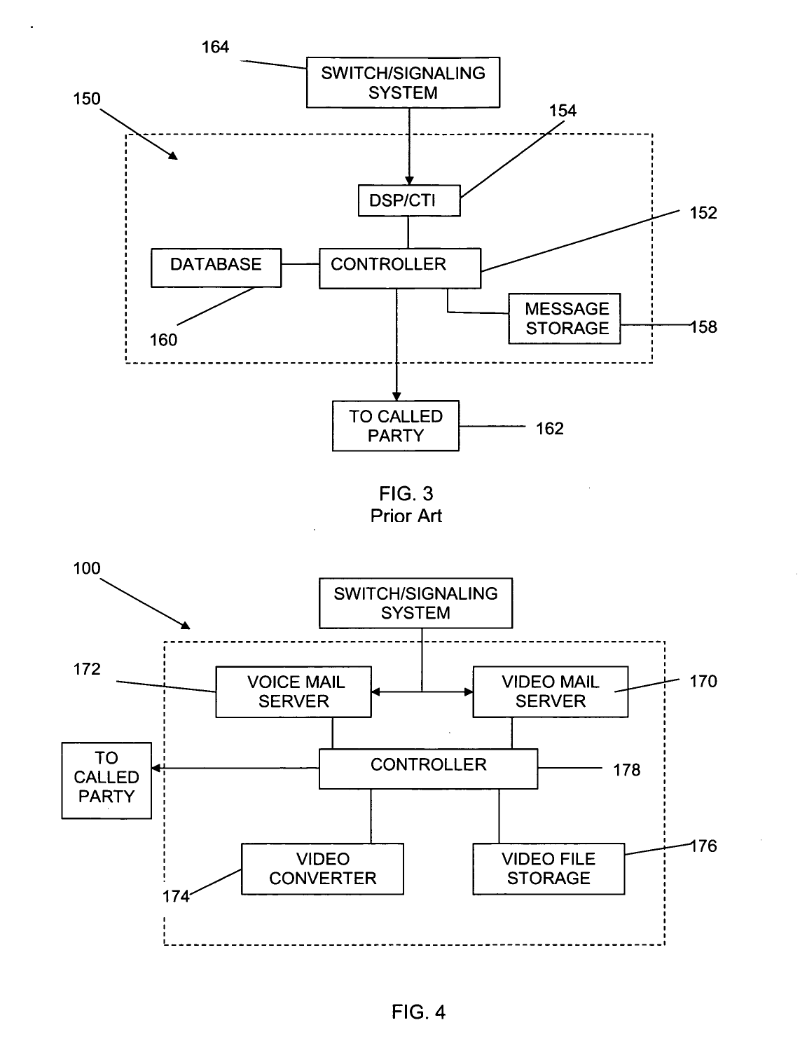

As shown in the schematic block diagram of FIG. 3, to which reference is now made, a standard mail server 150 generally comprises a controller 152 connected to a Digital Signal Processing (DSP) or any other Computer Telephone Interface (CTI) card 154, a database 156 and a message storage device 158.

Whenever a caller tries to call a subscriber of the mail service and the called party (subscriber) is unavailable, the switch transfers the call to the mail server 150. The mail server 150 can identify the telephone numbers of the caller and called party 160 from the signaling system 162 (SS7, PRI, SIP or H.324 or any other signaling system, known in the art). Upon receiving the call from the switch 162, the mail server uses the database to identify the called party and play the appropriate prompt and may request the caller to leave a message. The message is stored on a hard disk or any other storage device 158. The mail server may then notify the called party's handset that the subscriber has a message by sending a SMS via SMSC (SMS—Center) in the switch or via MWI notification (Message Waiting Indicator) using a signaling system such as SIP (Session Initiation Protocol) or TCAP any other similar technique, known in the art.

In a further embodiment, the mail server 150 may send a message to the subscriber's e-mail address (if the address is registered with the mail server). When a call is routed to the mail server, the software may associate, through a look-up table or database (such as SQL, available from by Microsoft Corporation Inc), the appropriate e-mail address of the called telephone owner. The incoming message is converted to a wave attachment utilizing the wave device associated with application software such as TAPI (Telephone Application Program Interface), for example, or directly using the Wave API (Application Program Interface). An e-mail with the attached wave file may then be sent via the Internet to the e-mail address associated with the called telephone.

In a yet further embodiment, the voice and video message may also be send to the called party's television set (TV) by storing it in appropriate format, such as MPEG 4, or similar, known in the art, for example at ITV server (interactive TV center).

Though the example of FIG. 3 refers to the called party being a subscriber of the unified mail server, the invention is not limited thereby but, as will be appreciated by persons knowledgeable in the art, a ‘virtual’ message maybe sent to the called party's telephone (the number being known from the signaling system) advising the called party that the caller has a text and/or video message for him.

Reference is now made to FIG. 4, which is a schematic illustration of the unified video mail server, generally designated 100. Unified video mail server 100 comprises a server for handling moving video and still photographic images 170 and a server for handling voice mail 172. In an alternative embodiment, the video server and voice server may be combined in a single server. Voice mail server 172 is similar to mail server 150, described hereinabove with respect to FIG. 3 and will not be described further.

The unified video mail server 100 further comprises a video converter 174 and storage device 176 for converting and storing the photographic and/or video files, respectively, connected to a controller 178.

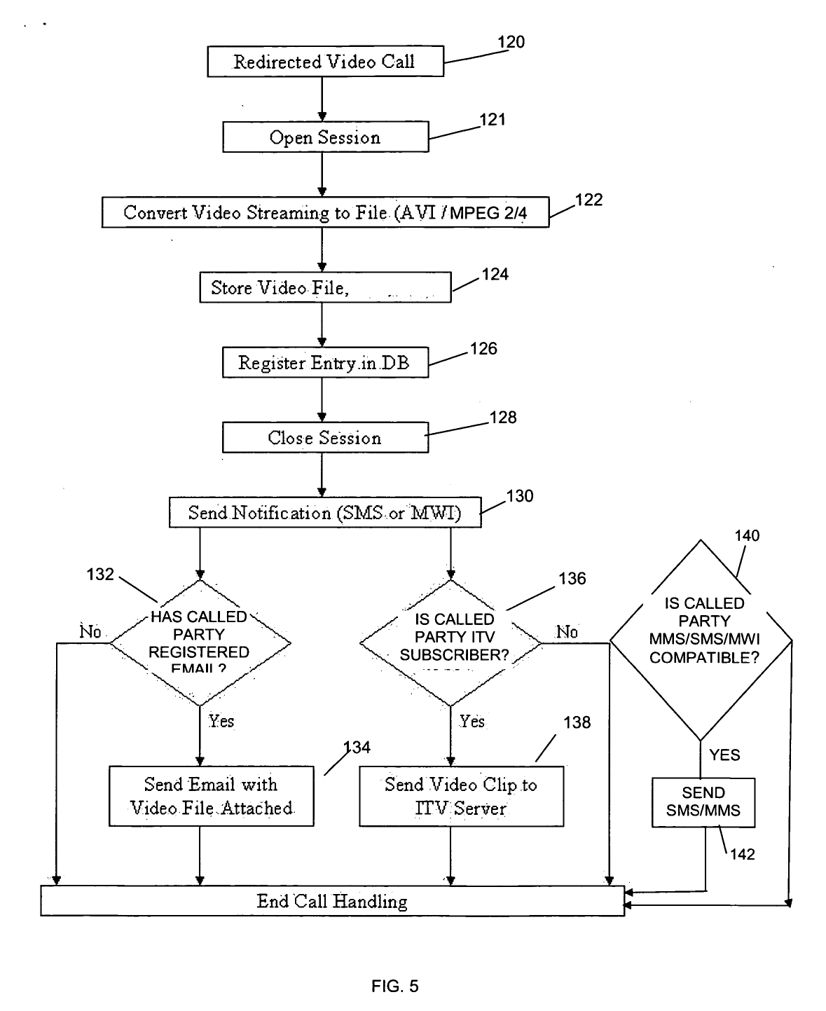

Reference is now made to FIG. 5, which is a schematic flow chart illustration of the communication of an unanswered or missed video call to the called person, according to an embodiment of the present invention.

When a video call is received at the unified video mail server 100, having been rerouted by the telephony switch 104 (step 120), the unified video mail server 100 opens a communication session (step 121) with the video caller 102. The caller 102 is invited to transmit a text message which may include an image, such as photograph from his mobile camera or video clip. The text message may be converted to a wave file, using wave API technology known in the art, for example.

The video image or clip may be converted using video converter 174 into a video file compression format (step 122), such as Audio Visual Interleave (AVI) by Microsoft Corporation or MPEG2 or MPEG4 (Moving Pictures Experts Group), for example, or similar known in the art file format. Any suitable compressed format that is highly flexible that enables storing and streaming audio and video may be utilized, and that may be run over networks like the Internet is suitable. Similarly, photographic images may be converted into JPEG or Bitmap files or similar, as is known in the art.

The video file may then be stored (step 124) within the video store 176 for later retrieval and transmission, using video storage technology, known in the art. For example, the files may be compressed and stored using the operating system (such as Unix or Linux, for example) of the video storage server.

The pertinent details of the video file and call session, including contact details of the caller and the called person, may then be entered into a database (step 126) to close the session (step 128).

A notification may then be sent to the called person 52 (step 130) using either SMS or MWI notification. The text message together with the video file may be sent either via email or to the called party's interactive television set (ITV).

If the called person 52 has an email address that has been registered with the mail server (query box 132), the email may be sent with a video file attachment (step 134), as is known in the art.

Alternatively, if the called person 52 is a registered user with an interactive TV (query box 136), the video clip may be sent directly to the ITV server (step 138), where the message can be stored for onward transmission to the called party, as will be described below.

Alternatively, if the called person 52 is not a registered user with an interactive TV (query box 136), but is SMS/MMS OR MWI compatible (query box 140), a message may be sent with a video file attachment (step 142), as is known in the art.

In an alternative embodiment, the photographic image or video clip may be stored on a dedicated web site. The notification may direct the called party to the web site, as is known in the art, where the photographic image and/or voice and video mail may be accessed via the Internet.

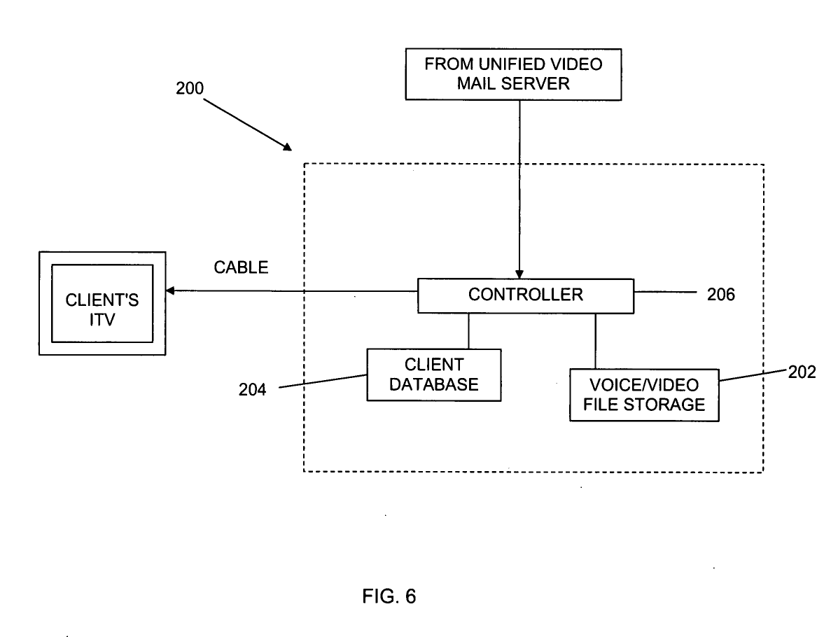

Reference is now made to FIG. 6, which is a schematic illustration of a interactive television center's (ITVC) voice/video mail server 200 and the forwarding of video messages to cable subscribers. The voice/video mail server 200 comprises at least one voice and video storage device 202 and a client database 204 containing details of subscribers connected to a processor 206.

Voice/video clips and messages which are received from the unified video mail server 100 are stored in the voice and video storage device 202. Software may associate, through the client database 204, the appropriate address of the called party. As is known in the art, each digital cable subscriber has an individually recognizable smart card device or similar device which enables the television company to transmit the specific television programs for which the client has subscribed. The subscriber may select programs (within his subscription package), via a remote control, which is generally only specifically associated with the subscriber's television set.

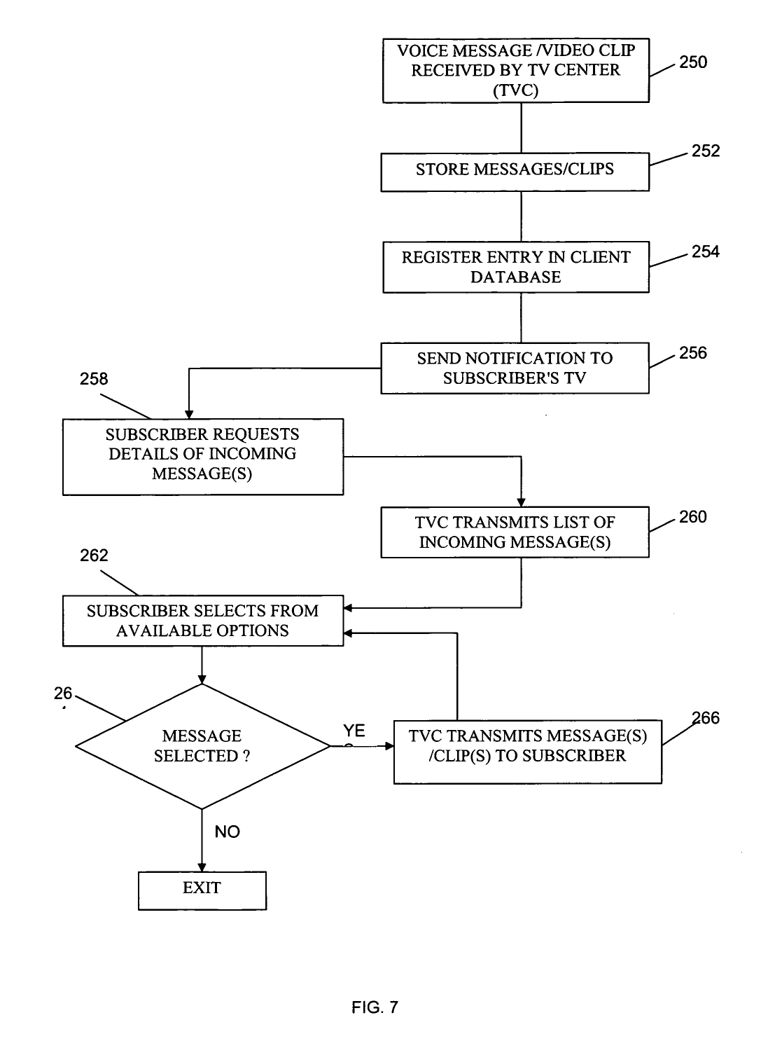

Reference is now made to FIG. 7 which is flow chart illustration of the transmission and retrieval of the text and/or video message to the called person's ITV (interactive television).

Voice messages and/or video clips which have been sent by the unified video mail server 100 are received at the ITV center (ITVC) (step 250) and stored (step 252) within the file storage device 202 until transmitted, using video storage technology, known in the art. The details of the message, including details of the caller and time of the message, for example, associated with the called person (subscriber) are entered into the client database (step 254).

A notification may then be transmitted to the TV of the subscriber (called person) (step 256) in the form of an overlay on the television program being transmitted at the time, using technology known in the art. For example, the overlay may be in the form of an envelope (indicating a message(s) received) together with instructions for viewing the message(s). The subscriber may request details of the incoming messages (step 258). The ITVC transmits details of the messages (in the form of an overlay, for example) which may be viewed, such as name of sender, date and time of message, for example (step 260).

The subscriber may select from the available options, such as selecting a message to view, paging up or down or exiting (step 262). If a message is selected (query box 264), the ITVC may transmit the message in the form of text or voice and transit the video clip (if applicable) (step 266), using one of the methods known in the art, such as streaming or file transfer.

In an alternative embodiment, where the called person receives television transmissions via satellite from the ITVC, messages and/or video clips may be transmitted in a similar manner. However, in this case, since the subscriber is unable to communicate with the ITVC via satellite, the interaction between the satellite TV subscriber and the ITVC may be through a separate telephone line. That is, instructions from the subscriber to the ITVC will be sent by telephone while the ITVC may transmit the messages and overlays as described hereinabove with reference to FIG. 6.

In a further embodiment of the invention, the television may be utilized as a means for sending SMS messages. SMS messages are commonly sent between cellular phones. A person wishing to send a SMS message to a party not having a cellular telephone or not being contactable by telephone may instead send a SMS message directly to the called party's television set. The method is similar to the method described above for forwarding video messages to the interactive TV (ITV) of a called party.

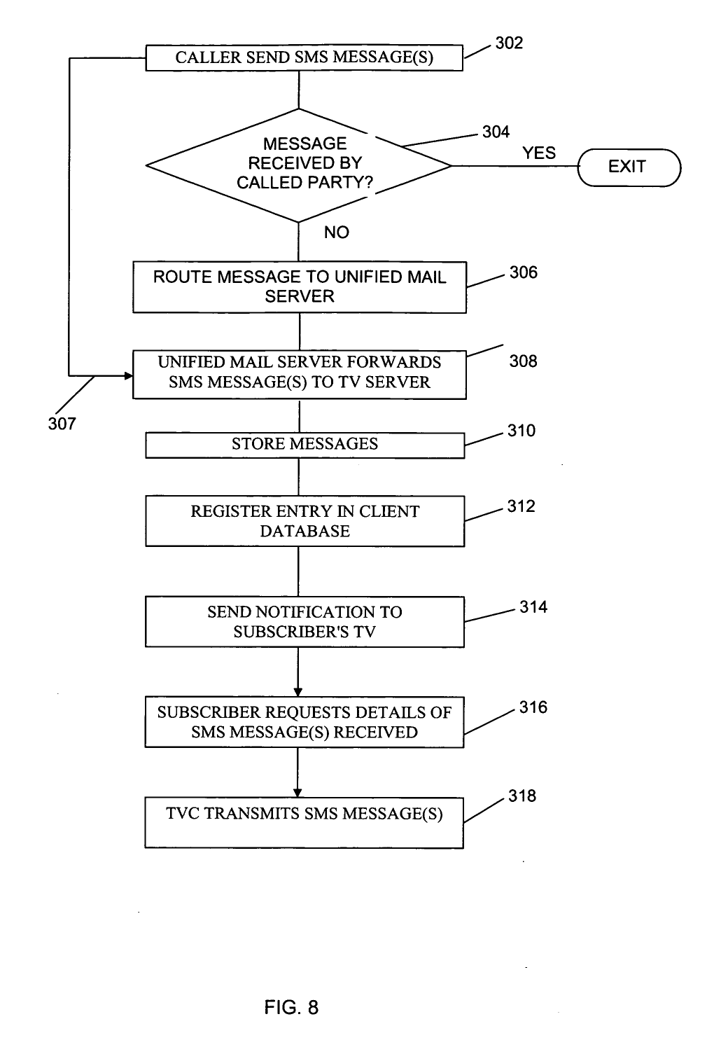

Reference is now made to FIG. 8, which is a flow chart illustration of the forwarding of a SMS message to the ITV set of a called party via an unified mail server.

The caller prepares and sends an SMS message to the called party (step 302). If the called party cannot receive a SMS message (query box 304), the message is routed to the unified mail server (step 306).

Alternatively, the caller may send the SMS message directly, via a dedicated telephone number, to the unified mail server (step 307). In the latter case, the caller would add details of the called party, such as his telephone number, as a header to the SMS message, for forwarding.

The unified mail server may then send the SMS message with details of the caller and called party to the ITV center (step 308), where the message may be stored (step 310) until transmitted. The details of the message, including details of the caller and time of the message, for example, associated with the called person (subscriber) are entered into the client database (step 312).

A notification may then be transmitted to the ITV of the subscriber (called person) (step 314) in the form of an overlay on the television program being transmitted at the time, as described hereinabove, using technology known in the art. The subscriber may request details of the incoming messages (step 316). The ITV Center transmits details of the SMS messages (in the form of an overlay, for example) which may be viewed, such as name of sender, date and time of message, for example (step 318).

While the invention has been described with respect to embodiments, it will be appreciated that these are set forth merely for purposes of example, and that variations and applications can be made. Many other variations, modifications and applications of the invention will also be apparent to those skilled in this field.

1. A method for storing and sending multimedia messaging service (MMS) messages comprising the steps of:
routing missed or unanswered telephone calls to an unified video mail server;
storing a message from the caller at the unified video mail server, said message comprising at least one of a group of messages including text, voice and video messages;
notifying the called party that at least one message has been received from the caller; and
forwarding the stored message to the called party.

2. The method according to claim 1, further comprising the step of:
identifying the telephone numbers of the caller and the called party from the signaling system.

3. The method according to claim 1, further comprising the step of:
converting a video image or clip into a video file compression format; and
storing said compressed video file.

4. The method according to claim 1, wherein the step of notifying comprises the step of:
sending an SMS message via a SMS Center in the telephone switch or via MWI notification (Message Waiting Indicator) to a telephone associated with the called party.

5. The method according to claim 1, wherein the step of notifying comprises the step of:
sending the message to the e-mail address associated with the called party.

6. The method according to claim 5, further comprising the step of:
attaching any of a group of files including a wave file, photograph image and video file with a text message.

7. The method according to claim 5, further comprising the step of:
storing any of a group of file attachments on a dedicated web site for retrieval by the called party.

8. The method according to claim 1, further comprising the step of:
the unified video mail server forwarding the message to a interactive television center (ITVC).

9. The method according to claim 8, further comprising the steps of:
the ITVC storing the received message;
entering details of the message in a database file associated with the called party; and
directly broadcasting a notification to the television set of the called party that a message has been received for the called party.

10. The method according to claim 8, further comprising the step of the ITVC ending a message to the called party via one of group of methods including sending an SMS message via a SMS Center in the telephone switch, sending a MMS message, or via MWI notification to a telephone associated with the called party.

11. The method according to claim 9, further wherein the step of broadcasting comprises the step of:
transmitting an overlay message via satellite or cable.

12. The method according to claim 9, further comprising the steps of:
the called party requesting details of the incoming messages; and
the ITVC transmitting the messages selected for viewing.

13. The method according to claim 12, wherein the step of requesting details comprises the step of:
communicating with the ITVC via cable or via a dedicated telephone line.

14. A method for sending SMS (Short Messaging Service) messages comprising the steps of:
routing the SMS message to an unified mail server;
the unified video mail server forwarding the messages to an interactive television center (ITVC); and
the ITVC broadcasting a notification to the television set of the called party that a SMS message has been received for the called party.

15. The method according to claim 14, further comprising the step of:
the ITVC storing the SMS message; and
entering details of the message in a database file associated with the called party.

16. The method according to claim 14, further wherein the step of broadcasting comprises the step of:
transmitting an overlay message via satellite or cable.

17. The method according to claim 14, further comprising the steps of:
the called party requesting details of the SMS messages; and
the ITVC transmitting the messages selected for viewing.

18. The method according to claim 17, wherein the step of requesting details comprises the step of:
communicating with the ITVC via cable or via a dedicated telephone line.

19. A system for storing and sending multimedia messaging service (MMS) messages comprising:
a router for routing missed or unanswered telephone calls;
an unified video mail server in communication with said router; said unified video mail server comprising at least one storage device for storing a message from the caller;
a notifier for notifying the called party that a message has been received from the caller; and
a forwarding device for forwarding the stored message to the called party.

20. The system according to claim 19, wherein said unified video mail server further comprises at least one of a group including a voice mail server and a video mail server.

21. The system according to claim 19, wherein said unified video mail server further comprises a video converter and a storage device for converting and storing video messages.

22. The system according to claim 19, further comprising:
an interactive television center (ITVC) in communication with the unified video mail server, said ITVC configured to receive messages from the unified mail server, said ITVC comprising:
a controller;
a client database in communication with the controller; and
a file storage device in communication with the controller,
wherein said ITVC is configured to transmit received messages to the Interactive Television of the called party.
